(19) United States
(12) Patent Application Publication
(10) Pub. No.: US 2023/0286408 A1
(43) Pub. Date: Sep. 14, 2023

(54) SYSTEMS AND METHODS FOR MANAGING AN ELECTRIC VEHICLE CHARGING STATION'S PARKING SPACE AVAILABILITY

(71) Applicant: Volta Charging, LLC, San Francisco, CA (US)

(72) Inventors: Jeffrey Kinsey, San Mateo, CA (US); Ramsey Meyer, San Francisco, CA (US); Michael Clement, Monterey, CA (US)

(21) Appl. No.: 17/973,655

(22) Filed: Oct. 26, 2022

Related U.S. Application Data
(60) Provisional application No. 63/272,367, filed on Oct. 27, 2021.

(51) Int. Cl. B60L 53/66; B60L 53/62; G06Q 10/0631

(52) U.S. Cl. CPC B60L 53/665; B60L 53/62; G06Q 10/06311

(57) ABSTRACT

Systems and methods are provided herein for providing a method for better allocation of EVCS services. This may be accomplished by an electric vehicle charging station (EVCS) updating a status of a parking space associated with the EVCS. For example, when the EVCS is charging an electric vehicle, the status of the parking space may be “occupied.” After the electric vehicle leaves the parking space, the EVCS may update the status of the parking space to “available.” The EVCS may also transmit the parking space status to electric vehicles requiring charging.

### BACKGROUND

The present disclosure relates to computer-implemented techniques for charging electric vehicles, and in particular to techniques for allocating parking spaces to electric vehicles.

### SUMMARY

As more consumers transition to electric vehicles, there is an increasing demand for electric vehicle charging stations (EVCSs). These EVCSs usually supply electric energy, either using cables or wirelessly, to the batteries of electric vehicles. For example, a user can connect their electric vehicle via cables of an EVCS, and the EVCS supplies electrical current to the user's electric vehicle. The cables and control systems of the EVCSs can be housed in kiosks in locations to allow a driver of an electric vehicle to park the electric vehicle close to the EVCS and begin the charging process. These kiosks may be placed in areas of convenience, such as in parking lots at shopping centers, in front of commercial buildings, or in other public places. Each EVCS usually services electric vehicles located in parking spaces close to said EVCS. With more electric vehicles on the road than ever before, there are often situations where the number of electric vehicles requiring EVCSs' parking spaces (e.g., to charge) outnumber the available parking spaces. Said situations can result in prolonged wait times, suboptimal charging allocation, electric vehicles running out of charge, and/or overall poor user experience. In view of these deficiencies, there exists a need for improved systems and methods for EVCS service management.

Various systems and methods described herein address these problems by providing a method for better allocation of EVCS services. An EVCS may use the status of a parking space corresponding to the EVCS to better allocate services. The status of a parking space relates to the availability (e.g., occupied, soon to be occupied, empty, soon to be empty, etc.) of the parking space serviced by an EVCS. One methodology for an EVCS to identify the status of a parking space is for the EVCS to determine if an electric vehicle is located in the parking space using one or more sensors (e.g., connection sensors, image sensors, ultrasound sensors, proximity sensors, etc.). For example, the EVCS may use a connection sensor, the dispensing of power, and/or ISO 15118 to determine that an electric vehicle is plugged into the EVCS and is located in the parking space. In another example, the EVCS may use a camera (sensor) to determine if an electric vehicle is located in the parking space. If there is an electric vehicle in the parking space, the EVCS may determine a first status of the parking space indicating that the parking space is occupied. If there is no electric vehicle in the parking space, the EVCS may determine that the first status of the parking space indicates that the parking space is empty. The EVCS can update the parking space status based on additional information. For example, if the EVCS determines that there is an electric vehicle in the parking space, the EVCS may determine a first status of the parking space indicating that the parking space is occupied. If the EVCS determines that the electric vehicle has left the parking space, the EVCS may determine a second status of the parking space indicating that the parking space is empty.

The EVCS may transmit a parking space status to a second device or devices (e.g., user device, group of user devices, server, etc.) based on one or more factors (e.g., parking space status type, parking space status change, proximity of second device, queue, auction, electric vehicle information, user information, etc.). For example, the EVCS may determine that a parking space changed from “occupied” (first parking space status) to “empty” (second parking space status). Based on the change in parking space status, the EVCS may transmit the second parking space status (“empty”) to a user device requesting a parking space to charge an electric vehicle within a threshold distance (e.g., one mile) of the EVCS. In another example, the EVCS may transmit the parking space status to a group of users who subscribe to a parking space notification service. In another example, the EVCS may transmit the parking space status to a user device associated with an electric vehicle having a charge below a first threshold (e.g., less than 20% charged). In another example, the EVCS may access a queue corresponding to a list of requests received from user devices, wherein the requests are queued in the order they are received. The EVCS may transmit the parking space status to a user device associated with the request next in the queue.

Parking space statuses may also include more granular information. For example, when an electric vehicle is parked in the parking space and the EVCS determines that the electric vehicle will be moving within a time period (e.g., 10 minutes), the parking space status may be “soon to be empty” and/or indicate the estimated time period (e.g., 10 minutes) when the parking space will be empty. When an electric vehicle is not parked in the parking space and the EVCS determines that the electric vehicle will be parking in the parking space within a time period (e.g., 10 minutes), the parking space status may be “soon to be occupied” and/or indicate the estimated time period (e.g., 10 minutes) until the parking space will be occupied.

The EVCS may use a first parking space status and user information (e.g., user activity, user location, user calendars, user purchases, user patterns, etc.) to determine a second parking space status of the parking space. For example, the EVCS may use a first parking space status (e.g., “occupied”) along with user information (e.g., the user is loading groceries into the electric vehicle) to determine that the second status of the parking space is “soon to be empty.” The EVCS can then transmit the second parking space status to a user device, a server, or a similar such device to help allocate EVCS services. For example, the EVCS may transmit the parking space status (“soon to empty”) to a user device of a second user, wherein the second user requires a parking space for charging their electric vehicle.

The EVCS can determine that user information relates to estimated time periods. For example, the EVCS may access a database with entries that associate user information with estimated time periods. A first entry may indicate that a user loading groceries (user activity) into an electric vehicle parked in the EVCS's parking space corresponds to approximately 10 minutes (time period) until the electric vehicle leaves the parking space. A second entry may indicate that a user of an electric vehicle parked in the EVCS's parking space paying for an item at a store (user purchase), corresponds to five minutes (time period) until the electric vehicle leaves the parking space because the user has to walk to the electric vehicle from the store. The entries may provide increasing granularity. For example, entries may specify that users with children loading groceries may correspond to a longer time period than users without children loading groceries. In another example, based on past behavior of users, some entries may specify that a first user doing an activity may correspond to a longer time period than a second user doing the same activity.

### BRIEF DESCRIPTION OF THE DRAWINGS

The below and other objects and advantages of the disclosure will be apparent upon consideration of the following detailed description, taken in conjunction with the accompanying drawings, in which like reference characters refer to like parts throughout, and in which:

FIG. 1 shows an illustrative diagram of a system for managing an EVCS's parking space, in accordance with some embodiments of the disclosure;

FIGS. 2A and 2B show block diagrams of an illustrative process for identifying the status of a parking space, in accordance with some embodiments of the disclosure;

FIGS. 3A and 3B show diagrams of illustrative tables for managing an EVCS's parking space, in accordance with some embodiments of the disclosure;

FIGS. 4A and 4B show illustrative diagrams of a user device generating notifications relating to EVCSs' parking spaces, in accordance with some embodiments of the disclosure;

FIG. 5 shows an illustrative block diagram of an EVCS system, in accordance with some embodiments of the disclosure;

FIG. 6 shows an illustrative block diagram of a user equipment device system, in accordance with some embodiments of the disclosure;

FIG. 7 shows an illustrative block diagram of a server system, in accordance with some embodiments of the disclosure;

FIG. 8 is an illustrative flowchart of a process for managing an EVCS's parking space, in accordance with some embodiments of the disclosure;

FIG. 9 is another illustrative flowchart of a process for managing an EVCS's parking space, in accordance with some embodiments of the disclosure; and

FIG. 10 is another illustrative flowchart of a process for managing an EVCS's parking space, in accordance with some embodiments of the disclosure.

### DETAILED DESCRIPTION

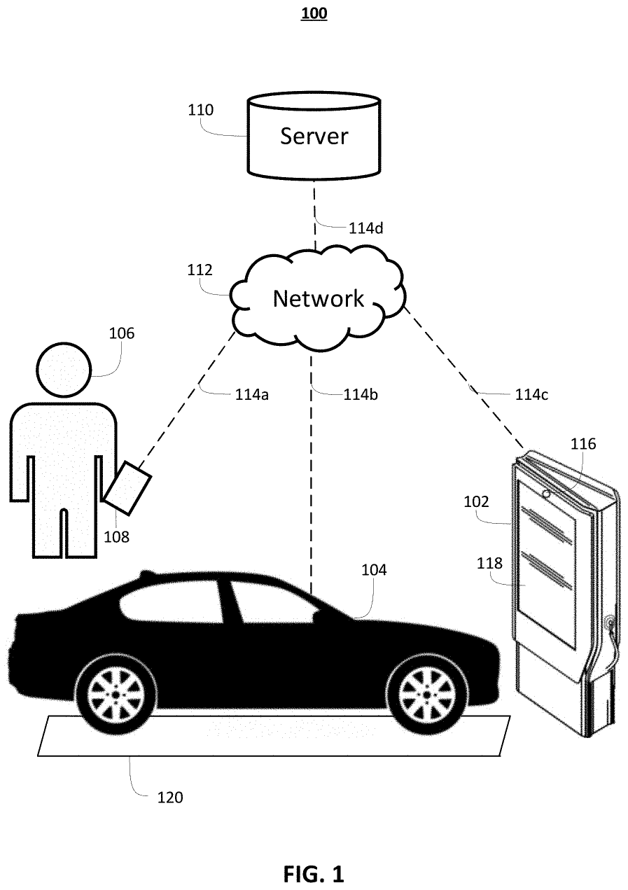

FIG. 1 shows an illustrative diagram of a system 100 for managing an EVCS's parking space 120, in accordance with some embodiments of the disclosure. In some embodiments, the EVCS 102 provides an electric charge to the electric vehicle 104 in the parking space 120 via a wired connection, such as a charging cable, or a wireless connection (e.g., wireless charging). The EVCS 102 may be in communication with the electric vehicle 104 and/or a user device 108 belonging to a user 106 (e.g., a driver, passenger, owner, renter, or other operator of the electric vehicle 104) that is associated with the electric vehicle 104. In some embodiments, the EVCS 102 communicates with one or more devices or computer systems, such as user device 108 or server 110, respectively, via a network 112.

In the system 100, there can be more than one EVCS 102, electric vehicle 104, user 106, user device 108, server 110, and network 112, but only one of each is shown in FIG. 1 to avoid overcomplicating the drawing. In addition, a user 106 may utilize more than one type of user device 108 and more than one of each type of user device 108. In some embodiments, there may be paths 114a-d between user devices, servers, EVCSs, and/or electric vehicles, so that the items may communicate directly with each other via communications paths, as well as other short-range point-to-point communication paths, such as USB cables, IEEE 1394 cables, wireless paths (e.g., Bluetooth, infrared, IEEE 802-11x, etc.), or other short-range communication via wired or wireless paths. In an embodiment, the devices may also communicate with each other directly through an indirect path via a communications network. The communications network may be one or more networks including the Internet, a mobile phone network, mobile voice or data network (e.g., a 4G, 5G, or LTE network), cable network, public switched telephone network, or other types of communications network or combinations of communications networks. In some embodiments, a communications network path comprises one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. In some embodiments, a communications network path can be a wireless path. Communications with the devices may be provided by one or more communications paths but are shown as a single path in FIG. 1 to avoid overcomplicating the drawing.

In some embodiments, the EVCS 102 determines a status of the parking space 120 by determining if an electric vehicle is located in the parking space 120. To determine if an electric vehicle is located in the parking space 120, the EVCS 102 can use parking space information received from one or more sensors. In some embodiments, the EVCS 102 uses one or more sensors to capture parking space information. For example, the sensors may be image (e.g., optical) sensors (e.g., one or more cameras 116), ultrasound sensors, depth sensors, IR cameras, RGB cameras, PIR cameras, thermal IR, proximity sensors, radar, tension sensors, NFC sensors, and/or any combination thereof. In some embodiments, one or more cameras 116 are configured to capture one or more images of an area proximal to the EVCS 102. For example, a camera may be configured to obtain a video or capture images of an area corresponding to the parking space 120 associated with the EVCS 102, a parking space next to the parking space 120 of the EVCS 102, and/or walking paths (e.g., sidewalks) next to the EVCS 102. In some embodiments, the camera 116 may be a wide-angle camera or a 360° camera that is configured to obtain a video or capture images of a large area proximal to the EVCS 102. In some embodiments, the camera 116 may be positioned at different locations on the EVCS 102 than what is shown. In some embodiments, the camera 116 works in conjunction with other sensors. In some embodiments, the one or more sensors (e.g., camera 116) can detect external objects within a region (area) proximal to the EVCS 102. In some embodiments, the EVCS 102 uses the parking space information (e.g., images from the camera 116) to determine that an electric vehicle 104 is located in the parking space 120.

In some embodiments, the EVCS 102 uses the parking space information to determine a parking space status. For example, if the EVCS 102 determines that the electric vehicle 104 is located in the parking space 120, the EVCS 102 can determine that the parking space status is a first status (e.g., occupied). If the EVCS 102 determines that the electric vehicle 104 has left the parking space 120, the EVCS 102 can determine that the parking space status is a second status (e.g., available).

In some embodiments, the EVCS 102 transmits a parking space status to a second device or devices (e.g., the first user device 108, a second user device, group of user devices, server, etc.) based on one or more factors (e.g., parking space status type, parking space status change, proximity of the requesting device, queue, auction, electric vehicle information, user information, etc.). In some embodiments, based on parking space information, the EVCS 102 determines that the parking space status changed from “occupied” (first parking space status) to “empty” (second parking space status). In some embodiments, in response to the change in status, the EVCS 102 transmits the second parking space status (“empty”) to a user device requesting a parking space to charge an electric vehicle within a threshold distance (e.g., one mile) of the EVCS 102. In some embodiments, the EVCS 102 transmits the parking space status to a group of users who subscribe to a parking space notification service. In some embodiments, the EVCS 102 transmits the parking space status to a user device associated with an electric vehicle having a charge below a first threshold (e.g., less than 20% charged). In some embodiments, the EVCS 102 accesses a queue corresponding to a list of requests received from user devices, wherein the requests are queued in the order they are received. The EVCS can transmit the parking space status to a user device associated with the request next in the queue. In some embodiments, the EVCS 102 transmits the parking space status to a database comprising a plurality of entries listing parking space statuses. In some embodiments, the EVCS 102 displays the parking space status on the display 118.

In some embodiments, the EVCS 102 uses user information (e.g., user activity, user location, user calendars, user purchases, user patterns, etc.) to update the parking space status. In some embodiments, to update a status of the parking space 120 using user information, the EVCS 102 determines a user 106 associated with the electric vehicle 104. In some embodiments, the user 106 may have to present some credentials (e.g., password, pin, biometrics, device, item, etc.) when requesting the EVCS 102 to charge their electric vehicle 104. For example, the user 106 may enter a password on the display 118 of the EVCS 102. In another example, the user 106 may enter a biometric password (e.g., fingerprint) on the user device 108, which is then communicated to the EVCS 102 and/or the server 110 via the network 112. In some embodiments, the credentials may be automatically inputted. For example, the user device 108 may automatically transmit user credentials to the EVCS 102 when the user device 108 is within a threshold distance of the EVCS 102. In some embodiments, the EVCS 102 uses characteristics of the electric vehicle 104 as credentials. For example, the EVCS 102 may automatically obtain characteristics of the electric vehicle 104 using ISO 15118 when the user 106 plugs in their electric vehicle 104. In some embodiments, the EVCS 102 uses the credentials to identify a user profile associated with the user 106. For example, the EVCS 102 may access a database (e.g., located on server 110) that associates credentials with a user profile. In some embodiments, the user profile stores information about the user 106. For example, the user profile may store user information related to the user 106, vehicle information of the electric vehicle 104 related to the user 106, and/or similar such information.

In some embodiments, the EVCS 102 uses user information obtained from the one or more sensors (e.g., camera 116) to update the parking space status. For example, the camera 116 may determine a first user activity (e.g., loading groceries) based on the camera 116 capturing images of the user 106 participating in the first activity (e.g., user 106 with groceries 122). In some embodiments, the EVCS 102 changes the parking space status (“occupied”) to an updated parking space status (“soon to be available”) using the user information (e.g., loading groceries).

In some embodiments, the EVCS 102 uses the received user information to determine an estimated time period for the updated parking space status. For example, the EVCS 102 may access a database with entries that associate user information with estimated time periods. In some embodiments, a first entry indicates that the user 106 loading groceries (user activity) into the electric vehicle 104 parked in the parking space 120 corresponds to approximately 10 minutes (time period) until the electric vehicle 104 leaves the parking space 120. In some embodiments, a second entry indicates that the user 106 of the electric vehicle 104 parked in the parking space 120 paying for an item at a store (user purchase) corresponds to five minutes (time period) until the electric vehicle 104 leaves the parking space 120. In some embodiments, the entries provide additional granularity. For example, entries may specify that users with children loading groceries may correspond to a longer time period than users without children loading groceries. In some embodiments, the database comprises customized entries based on certain users. For example, based on past behavior of the user 106, some entries may specify that the user 106 doing an activity (e.g., loading groceries) may correspond to a longer time period than a second user doing the same activity. In some embodiments, the EVCS 102 includes the estimated time period in and/or along with the updated parking space status. For example, the updated parking space status may be “will be available in 10 minutes.”

In some embodiments, the EVCS 102 uses characteristics (e.g., model, make, specifications, condition, etc.) of the electric vehicle 104 to determine the parking space status. For example, the EVCS 102 may determine an electric vehicle characteristic that the electric vehicle's battery is 95% charged. In some embodiments, the EVCS 102 uses the characteristics of the electric vehicle 104 (battery being 95% charged) to determine that the electric vehicle 104 is almost done charging and will likely leave the parking space 120 once charging is complete. In some embodiments, the EVCS 102 uses the characteristics of the electric vehicle 104 (battery being 95% charged) to determine that the parking space status is “soon to be available.”

In some embodiments, the EVCS 102 uses characteristics of the electric vehicle 104 in conjunction with the user information to determine the parking space status. In some embodiments, the EVCS 102 uses a characteristic of the electric vehicle 104 (battery being 5% charged) in conjunction with user information (no calendar events) to determine the parking space status to be “will be occupied for one hour.” In some embodiments, the EVCS 102 makes this determination because users assume that they will spend more time at a location comprising an EVCS when their electric vehicle has a low battery percentage because it takes more time to charge an electric vehicle with a low battery percentage. In some embodiments, the EVCS 102 also displays a first piece of media (e.g., movie ticket sale) on the display 118 for the user 106 because the first piece of media corresponds to an activity with a timeframe similar to the parking state status (e.g., “will be occupied for one hour”). In some embodiments, the EVCS 102 uses a characteristic of the electric vehicle 104 (battery being 90% charged) in conjunction with user information (no calendar events) to determine the parking space status to be “will be available in 15 minutes.” In some embodiments, the EVCS 102 makes this determination because users assume that they will not spend as much time at a location comprising an EVCS when their electric vehicle has a higher battery percentage because it takes less time to charge an electric vehicle with a higher battery percentage. In some embodiments, the EVCS 102 displays a second piece of media (e.g., coffee sale) for the user 106 because the second media corresponds to an activity with a timeframe similar to the parking state status (e.g., “will be available in 15 minutes”).

In some embodiments, the EVCS 102 uses location information (e.g., local patterns, electrical grid information, site information, etc.) to determine the parking space status. For example, the user 106 may request the EVCS 102 to charge their electric vehicle 104 at a first time of day, and the EVCS 102 can retrieve location information (e.g., average charging time for users during the first time of day is one hour). In some embodiments, the EVCS 102, uses the location information (e.g., average charging time for users during the first time of day is one hour) to determine that the parking space status is “will be occupied for one hour.”

In some embodiments, the EVCS 102 uses location information in conjunction with user information to determine the parking space status. For example, the user 106 may request the EVCS 102 to start charging their electric vehicle 104, and the EVCS 102 may retrieve a first user information indicating that the user 106 purchased an item for pickup from a location (e.g., restaurant) within a threshold distance (e.g., one mile) from the EVCS 102. In some embodiments, the EVCS 102 determines a first local pattern, that users who purchased an item for pickup from the location wait an average timeframe (e.g., 15 minutes). In some embodiments, the EVCS 102 uses the location information (that users who purchased an item for pickup from the location wait an average of 15 minutes) in conjunction with user information (the user 106 purchased the item for pickup from the location) to determine that the parking space status is “will be available in 15 minutes.”

In some embodiments, the EVCS 102 leverages machine learning to determine the parking space statuses, user information, electric vehicle characteristics, location information, and/or similar such information. The EVCS may use any combination of user information, electric vehicle characteristics, location information, and/or similar such information to determine the parking space statuses. In some embodiments, the referenced electrical vehicles may be autonomous electric vehicles. Although the term “electric vehicles” is used, many of the methodologies described herein may be applied to non-electric vehicles.

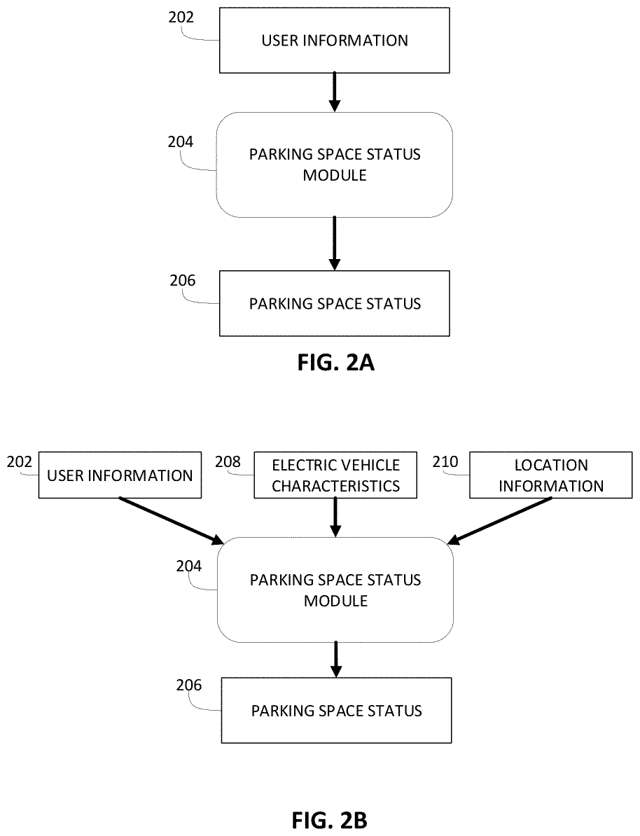

FIGS. 2A and 2B show block diagrams of an illustrative process for identifying the status of a parking space, in accordance with some embodiments of the disclosure. In some embodiments, FIGS. 2A and 2B use the same or similar methods and devices described in FIG. 1.

FIG. 2A shows a parking space status module 204 receiving user information 202 and outputting a parking space status 206. In some embodiments, the parking space status 206 corresponds to the parking space statuses (e.g., first parking space status, updated parking space status, etc.) described in FIG. 1. As described herein, the parking space status module 204 may be located in an EVCS (e.g., EVCS 102), a server (e.g., server 110), a user device (e.g., user device 108) and/or any combination thereof. In some embodiments, the parking space status model 204 has access to parking space information received from one or more sensors.

In some embodiments, to determine the parking space status 206, the parking space status module 204 uses user information 202 (e.g., user location, user calendars, user purchases, user patterns, etc.). The parking space status module 204 has a variety of methods of obtaining the user information 202 (e.g., receiving the user information 202 from a database, a user, a third-party provider, etc.). The parking space status module 204 can use one piece of user information 202 or a plurality of user information to determine the parking space status 206. In some embodiments, different user information is weighted according to significance. For example, a first piece of user information indicating that the user has an upcoming event may be weighted higher than a second piece of user information indicating that the user made a purchase two weeks ago. In some embodiments, the parking space status module 204 uses the different weights in determining the parking space status 206. In some embodiments, the parking space status module 204 outputs the parking space status 206 to an EVCS (e.g., EVCS 102), a server (e.g., server 110), a user device (e.g., user device 108) and/or any combination thereof.

FIG. 2B shows a parking space status module 204 receiving user information 202, electric vehicle characteristics 208, and location information 210 and outputting a parking space status 206. In some embodiments, FIG. 2B generates a parking space status 206 in the same or similar way as described above in FIG. 2A. In some embodiments, the parking space status module 204 uses any combination of parking space information, user information 202, electric vehicle characteristics 208, location information 210, and/or similar such information to determine the parking space status 206. In some embodiments, the parking space status module 204 receives only the user information 202 and the electric vehicle characteristics 208 and determines the parking space status 206. In some embodiments, the parking space status module 204 receives only the user information 202 and the location information 210 and determines the qparking space status 206. The parking space status module 204 can use one or more pieces of parking space information, user information 202, electric vehicle characteristics 208, and/or location information 210 to determine the parking space status 206. In some embodiments, different information is weighted according to significance. In some embodiments, the parking space status module 204 uses the different weights in determining the parking space status 206. In some embodiments, the parking space status module 204 outputs the parking space status 206 to an EVCS (e.g., EVCS 102), a server (e.g., server 110), a user device (e.g., user device 108) or any combination thereof.

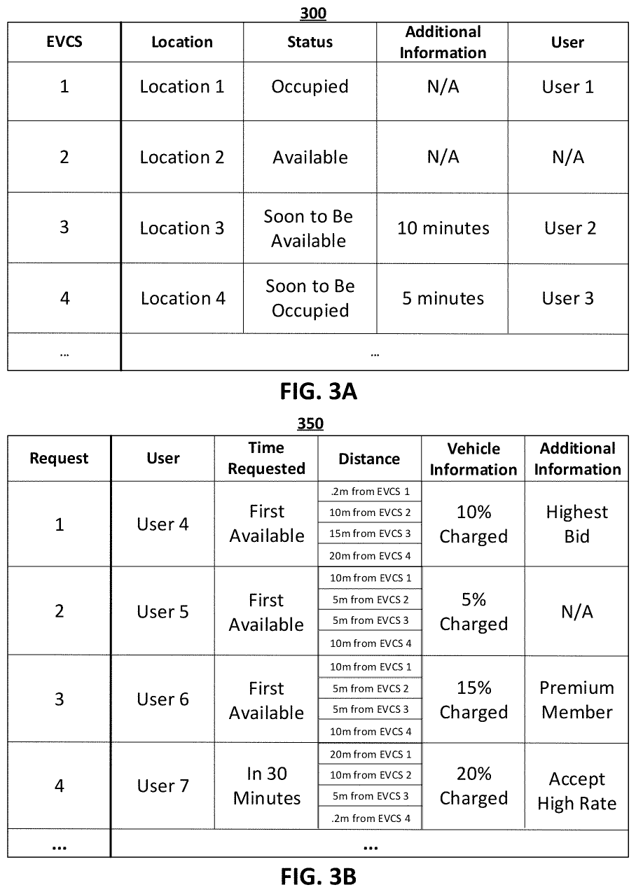

FIG. 3A and FIG. 3B show diagrams of illustrative tables for managing an EVCS's parking space, in accordance with some embodiments of the disclosure. In some embodiments, table 300 and table 350 can illustrate tables of entries contained in a storage and maintained by an EVCS, a server, and/or similar such device.

Table 300 comprises four entries corresponding to four different EVCSs (EVCS 1, EVCS 2, EVCS 3, and EVCS 4). As shown, EVCS numbers are used as identifiers for the entries, but any similar such identifiers can be used. Table 300 includes additional information for each entry. In some embodiments, table 300 comprises all EVCSs of a certain type (category (Level 1, Level 2, Level 3, etc.), brand, etc.). In some embodiments, table 300 is updated as EVCSs are installed. For example, once EVCS 4 is installed, the entry corresponding to EVCS 4 is generated. In some embodiments, the referenced EVCSs (EVCS 1, EVCS 2, EVCS 3, and EVCS 4) transmit EVCS information to a device that maintains table 300. In some embodiments, one or more EVCSs maintain tables similar to table 300 and update said tables upon receiving communications from other EVCSs. In some embodiments, table 300 is the result of filtering a larger table. For example, the larger table may comprise all EVCSs of a certain type, and table 300 may comprises all EVCS of the certain type within a threshold distance of a first location. In some embodiments, the first location may be indicated by a user, an electric vehicle, and/or a similar such source. For example, an electric vehicle may request charging from an EVCS and provide a location of said electric vehicle. In some embodiments, table 300 may be generated to display all EVCSs that are within a threshold distance (e.g., drivable distance) of the electric vehicle.

In some embodiments, each EVCS is associated with a location. For example, EVCS 1 is associated with location 1. In some embodiments, upon installation, EVCS 1 transmits a notification to the device that maintains table 300 indicating that EVCS 1 is online and is located in location 1. In some embodiments, EVCS 1 uses GPS coordinates to specify its location. In some embodiments, a network administrator manually inputs the location of EVCS 1 upon installation of EVCS 1.

In some embodiments, each EVCS is associated with a parking space status, additional information, and user information. In some embodiments, the parking space status is determined using the same or similar methodologies as described above. In some embodiments, the additional information relates to the parking space status. For example, the parking space status of EVCS 3 is “Soon to Be Available,” and the additional information indicates that the EVCS is going to be available in 10 minutes. In some embodiments, the additional information is determined using the same or similar methodologies as described above. For example, EVCS 3 may determine a first parking space status (“Soon to Be Available”) based on detecting a user loading groceries into an electric vehicle located in EVCS 3's parking spot and use the activity (loading groceries) to determine that the user should be done loading groceries in 10 minutes. In some embodiments, additional information may not be available based on lack of information. For example, if EVCS 1 lacks enough information to determine when User 1 is going to leave EVCS 1's parking space, table 300 will indicate that additional information is “Not available or N/A.” In some embodiments, a user may reserve and/or indicate that they are heading toward an EVCS. For example, User 3 may send a notification to the device managing table 300 and/or to EVCS 4 indicating that User 3 will arrive at EVCS 4 in five minutes. In some embodiments, this notification is transmitted using a user device and/or electric vehicle associated with User 3.

In some embodiments, table 300 reflects EVCS information transmitted by the respective EVCSs. In some embodiments, one or more EVCSs transmit EVCS information whenever there is a change in EVCS information. For example, if EVCS 1's status changes from “Occupied” to “Available” EVCS 1 can send a notification to the device that maintains table 300. In some embodiments, one or more EVCSs transmit EVCS information after a certain time period (e.g., every five seconds, every minute, every 10 minutes, etc.). In some embodiments, one or more EVCSs transmit EVCS information whenever requested (e.g., from the device that maintain table 300). In some embodiments, an EVCS (e.g., EVCS 3) transmits EVCS information using one or more data packets (e.g., using IPv6) to the one or more devices maintaining table 300. Table 300 is just one embodiment used to display an illustrative table for managing an EVCS's parking space; similar storage formats, methods, and information can be used. For example, additional information or less information may be stored in table 300. Although only four EVCSs are show, in some embodiments, any number of EVCSs can be stored in table 300.

Table 350 comprises four entries corresponding to four requests (Request 1, Request 2, Request 3, and Request 4). As shown, request numbers are used as identifiers for the entries, but similar such identifiers can be used. Table 350 includes information related to each entry. In some embodiments, table 350 comprises all requests of a certain type (request for a brand of charger, request for a category (Level 1, Level 2, Level 3, etc.) of charger, request for chargers within a certain location, etc.). In some embodiments, table 350 is updated as charging requests are received. In some embodiments, a user submits a charge request using a user device. For example, User 4 may submit Request 1 using a smart phone. In some embodiments, an electric vehicle associated with a user submits a charge request. For example, the electric vehicle associated with User 5 may submit Request 2. In some embodiments, the requests are submitted automatically in response to one or more conditions. For example, if the battery percentage of an electric vehicle (e.g., electric vehicle corresponding to User 5) falls below a first threshold (e.g., below 6% charged), the electric vehicle automatically submits a charging request (e.g., Request 2). Although only four requests are shown, in some embodiments, any number of requests can be stored in table 350.

In some embodiments, the requests are transmitted to one or more devices that maintain table 350. In some embodiments, one or more EVCSs maintain tables similar to or the same as table 350 and update said tables upon receiving charging requests. In some embodiments, table 350 is the result of filtering a larger table. For example, the larger table may comprise all charging requests of a certain type (e.g., Level 2 charger) and table 350 comprises all charging requests of the certain type within a threshold distance of a first location. In some embodiments, the first location may be the location of one or more EVCSs. For example, one or more EVCSs may be located at a first location (e.g., a mall) and service charging requests may be submitted within a threshold distance (e.g., 20 miles) of the first location.

In some embodiments, each request is associated with a user, time requested, distance, vehicle information, and/or additional information. In some embodiments, some or all of this information is inputted by the user. In some embodiments, some or all of this information is determined by an electric vehicle and/or user device associated with the user. For example, Request 2 may have been submitted by an electric vehicle associated with User 5. In some embodiments, the electric vehicle determines the electric vehicle is 5% charged and requires the first available EVCS to charge the electric vehicle. In some embodiments, the electric vehicle submits the charging request, wherein the charging request identifies the user associated with the electric vehicle (e.g., User 5) along with vehicle information (e.g., location of the electric vehicle, battery charge of the electric vehicle, time of charge required, etc.).

In some embodiments, one or more requests indicate time periods when charging is requested. For example, a request can indicate immediate charging by requesting the “First Available” EVCS. In some embodiments, a request can indicate that charging will not be required until a later time. For example, if a user plans to go grocery shopping after finishing a television show, the user may request an EVCS after a first time period (in 30 minutes). In some embodiments, a request can be used to reserve a parking space for a user.

In some embodiments, a request indicates a location. For example, a request may indicate a location where an electric vehicle is located. In some embodiments, a location is used to determine one or more distances between the location and EVCSs. For example, the electric vehicle associated with Request 1 is 0.2 miles from EVCS 1, 10 miles from EVCS 2, 15 miles from EVCS 3, and 20 miles from EVCS 4. In some embodiments, the distances are included in the request (e.g., Request 1). In some embodiments, the distances are calculated from the location included in the request (e.g., Request 1). In some embodiments, after receiving a first location, the device that maintains table 350 determines one or more EVCSs within a threshold distance (e.g., 20 miles) of the first location. In some embodiments, the device that maintains the database uses the EVCS locations (Location 1, Location 2, Location 3, and Location 4) from table 300 to determine the distance between the first location and the one or more EVCSs within a threshold distance of the first location.

In some embodiments, a request indicates vehicle information. Although battery percentages are shown, any type of vehicle information may be included with a request. For example, the make, model, condition, battery size, etc., may be included in a charge request.

In some embodiments, a request indicates additional information. In some embodiments, the additional information relates to one or more conditions relating to the request. For example, User 4 may have bid the highest for their request (Request 1) to be placed at the front of the queue; accordingly, Request 1 indicates that it is associated with the “Highest bid.” In some embodiments, the one or more conditions indicate if the user and/or electric vehicle associated with the request is subscribed to a service. For example, because User 6 is subscribed to a premium service, Request 3 may indicate that the request is from a “Premium member.” In some embodiments, the one or more conditions indicate if the user and/or electric vehicle associated with the request agrees to an increased charging rate. For example, because User 7 agreed to a higher than normal charging rate, Request 4 may indicate that the request accepts higher charging rates. In some embodiments, the additional information causes the corresponding requests to be assigned an EVCS parking space more quickly or more slowly than requests without the additional information.

In some embodiments, the information contained in the requests (Request 1, Request 2, Request 3, and Request 4) is used to select an EVCS parking space for each request. For example, a request indicating that an electric vehicle is 5% charged may be assigned to an EVCS before a second request indicating that an electric vehicle is 15% charged. In some embodiments, the information contained in the request is weighted to determine assignment to an EVCS parking space. For example, the percent charge of an electric vehicle may be weighted lower than a user bidding the highest amount for an EVCS parking space. Accordingly, Request 1 may be assigned to an EVCS parking space before Request 2, despite Request 2 corresponding to an electric vehicle with battery having a lower percent charge.

In some embodiments, a user device and/or an electric vehicle transmits a charging request using one or more data packets (e.g., using IPv6) to the one or more devices maintaining table 350. In some embodiments, the same device or devices maintain table 300 and table 350. In some embodiments, machine learning is utilized to designate EVCS parking spaces from table 300 to charging requests from table 350 based on the recorded information. Table 350 is just one embodiment used to display an illustrative table for managing an EVCS's parking space; similar storage formats, methods, and information can be used. For example, additional information or less information may be stored in table 350.

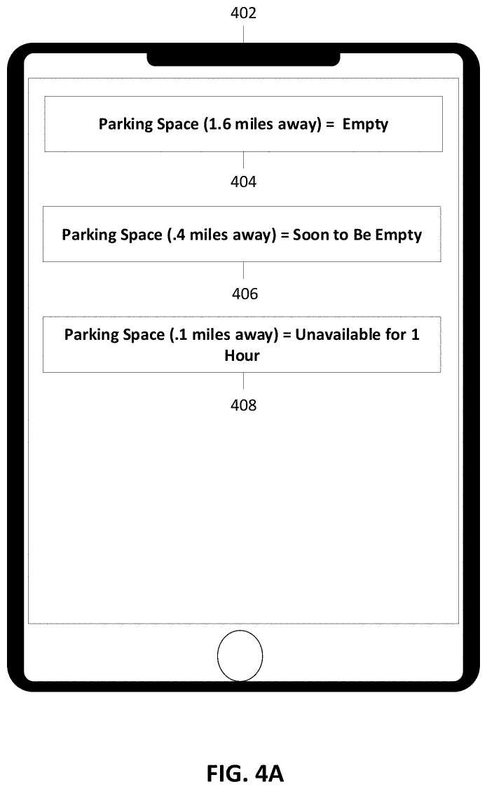

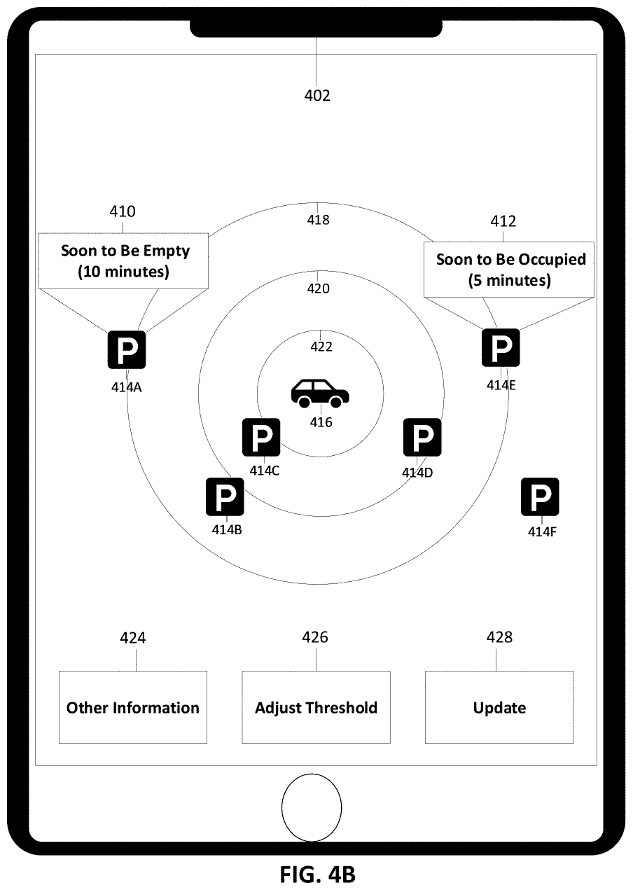

FIGS. 4A and 4B show illustrative diagrams of a user device 402 generating notifications relating to an EVCS's parking space, in accordance with some embodiments of the disclosure. Although a smartphone is used in this example, a user device 402 may be any device or devices capable of displaying a parking space status such as televisions, laptops, tablets, smartphones, and/or similar such devices.

FIG. 4A shows an embodiment where the user device 402 receives one or more notifications indicating one or more parking space statuses. In some embodiments, a first notification 404 indicates a first parking space status, a second notification 406 indicates a second parking space status, and a third notification 408 indicates a third parking space status. In some embodiments, a notification is transmitted to the user device 402 when a parking space status is generated. For example, if a first EVCS determines that a first parking space is available, it may transmit the first notification 404 to the user device 402. In some embodiments, a notification is transmitted to the user device 402 when a parking space status is updated. For example, if a second EVCS determines that a second parking space has an electric vehicle that is going to be leaving soon based on a user activity, the second EVCS may transmit the second notification 406 to the user device 402. In some embodiments, the most recent parking space status is transmitted to the user device 402. In some embodiments, the parking space status corresponding to the parking space that is the closest to the user device 402 is transmitted to the user device 402. In some embodiments, the parking space status corresponding to the parking space that is the closest to the user device 402 and is available and/or is going to be available within a threshold time period is transmitted to the user device 402. In some embodiments, a user is able to select notification settings relating to a first time period and a first threshold relating to available parking spots. For example, a user of the user device 402 may select parking spaces that are available and/or will be available within one mile in the next five minutes. In some embodiments, one or more EVCSs, servers, and/or similar such devices transmit the notifications to the user device 402.

In some embodiments, one or more notifications (e.g., first notification 404, second notification 406, third notification 408, etc.) may be transmitted to the user device 402 based on one or more factors (e.g., proximity, queue, auction, electric vehicle information, user information, etc.). In some embodiments, one or more notifications related to a first location are transmitted to the user device 402 when the user device 402 is within a threshold distance of the first location. In some embodiments, if an electric vehicle associated with the user device 402 meets a first parameter, one or more notifications are transmitted to the user device 402. For example, if the electric vehicle associated with the user device 402 has a 5% battery charge, the one or more notifications may be transmitted to the user device 402. In some embodiments, only notifications relating to parking spaces within a threshold distance of the user device 402 are transmitted, wherein the threshold distance relates to the distance the electric vehicle is able to travel given the percentage of the electric vehicle's battery charge. In some embodiments, one or more notifications are transmitted to the user device 402 based on user information associated with the user device 402. For example, if the user information associated with the user device 402 indicates that the user has an event scheduled at a first location, notifications relating to parking spaces within a threshold distance of the event may be transmitted to the user device 402. In some embodiments, one or more notifications are sent to user devices subscribed to a notification service. In some embodiments, one or more notifications are sent to user devices belonging to users who pay for the notifications. In some embodiments, a user can select one or more notifications to receive additional information. For example, a user may select the first notification 404 and see the exact location of the parking space. In some embodiments, a user can select a notification and receive directions to the parking space corresponding to the notification.

FIG. 4B shows an embodiment where a user launches a parking space application on a user device 402. In some embodiments, the user device 402 displays one or more parking spaces (e.g., parking spaces 414A-F) and/or parking space statuses (e.g., first parking space status 410, second parking space status 412, etc.) located within a threshold distance of the user's location 416. The user's location 416 may be determined using a global positioning system, cell tower data, Wi-Fi hotspot information, user profile information, and/or similar such information. In some embodiments, the first parking space status 410 reflects the parking space status of the first parking space 414A. In some embodiments, the parking space statuses (e.g., first parking space status 410, second parking space status 412, etc.) change color, shape, animation, to indicate the parking space status. Although the parking space statuses are shown as banners, similar such indications can be used. For example, the parking spaces 414A-F may change color, shape, animation, icon, etc., based on the associated parking space status.

In some embodiments, the user device 402 displays an “Other Information” option 424. A user can select the other information option 424 to view other parking space status-related information (e.g., parking space statuses in other locations, parking space statuses trends, etc.). In some embodiments, the user equipment device 402 displays an “Adjust Threshold” option 426. In some embodiments, the user can select the adjust threshold option 426 to cause the user device 402 to display parking spaces (e.g., parking spaces 414A-F) and/or parking space statuses (e.g., first parking space status 410, second parking space status 412, etc.) located within a different threshold distance of the user's location 416. In some embodiments, the user can select the adjust threshold option 426 to cause the user device 402 to display only certain categories of parking space statuses (e.g., available, soon to be available, occupied, soon to be occupied, etc.). In some embodiments, the user can select the adjust threshold option 426 to cause the user device 402 to display certain categories of spaces statuses during a certain time period. For example, all parking spaces that are available or soon to be available for the next five minutes. In some embodiments, the user equipment device 402 displays an “Update” option 428. In some embodiments, the user can select the update option 428 to cause the user device 402 to refresh the parking spaces (e.g., parking spaces 414A-F) and/or parking space statuses (e.g., first parking space status 410, second parking space status 412, etc.). In some embodiments, the parking spaces (e.g., parking spaces 414A-F) and/or parking space statuses (e.g., first parking space status 410, second parking space status 412, etc.) are updated periodically (e.g., every 30 seconds) without the user's input.

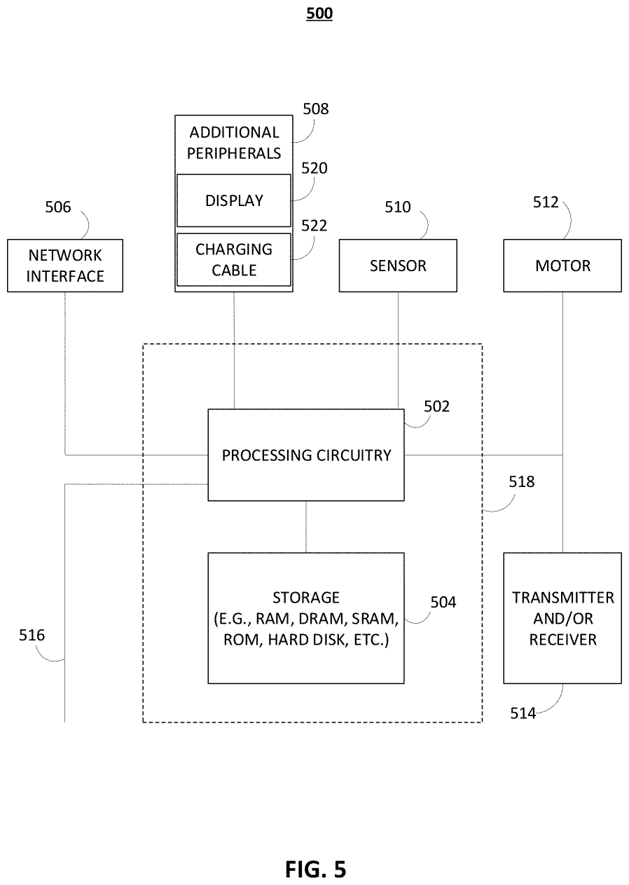

FIG. 5 shows an illustrative block diagram of an EVCS system 500, in accordance with some embodiments of the disclosure. In particular, EVCS system 500 of FIG. 5 may be the EVCSs depicted in FIG. 1. In practice, and as recognized by those of ordinary skill in the art, items shown separately could be combined and some items could be separated. In some embodiments, not all shown items must be included in EVCS 500. In some embodiments, EVCS 500 may comprise additional items.

The EVCS system 500 can include processing circuitry 502 that includes one or more processing units (processors or cores), storage 504, one or more network or other communications network interfaces 506, additional peripherals 508, one or more sensors 510, a motor 512 (configured to retract a portion of a charging cable), one or more wireless transmitters and/or receivers 514, and one or more input/output (I/O) paths 516. I/O paths 516 may use communication buses for interconnecting the described components. I/O paths 516 can include circuitry (sometimes called a chipset) that interconnects and controls communications between system components. EVCS 500 may receive content and data via I/O paths 516. The I/O path 516 may provide data to control circuitry 518, which includes processing circuitry 502 and a storage 504. The control circuitry 518 may be used to send and receive commands, requests, and other suitable data using the I/O path 516. The I/O path 516 may connect the control circuitry 518 (and specifically the processing circuitry 502) to one or more communications paths. I/O functions may be provided by one or more of these communications paths but are shown as a single path in FIG. 5 to avoid overcomplicating the drawing.

The control circuitry 518 may be based on any suitable processing circuitry such as the processing circuitry 502. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). The EVCS parking space management functionality can be at least partially implemented using the control circuitry 518. The EVCS parking space management functionality described herein may be implemented in or supported by any suitable software, hardware, or combination thereof. The EVCS parking space management functionality can be implemented on user equipment, on remote servers, or across both.

The control circuitry 518 may include communications circuitry suitable for communicating with one or more servers. The instructions for carrying out the above-mentioned functionality may be stored on the one or more servers. Communications circuitry may include a cable modem, an integrated service digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths. In addition, communications circuitry may include circuitry that enables peer-to-peer communication of user equipment devices, or communication of user equipment devices in locations remote from each other (described in more detail below).

Memory may be an electronic storage device provided as the storage 504 that is part of the control circuitry 518. As referred to herein, the phrase “storage device” or “memory device” should be understood to mean any device for storing electronic data, computer software, or firmware, such as random-access memory, read-only memory, high-speed random-access memory (e.g., DRAM, SRAM, DDR RAM, or other random-access solid-state memory devices), non-volatile memory, one or more magnetic disk storage devices, optical disk storage devices, flash memory devices, other non-volatile solid-state storage devices, quantum storage devices, and/or any combination of the same. In some embodiments, the storage 504 includes one or more storage devices remotely located, such as database of server system that is in communication with EVCS 500. In some embodiments, the storage 504, or alternatively the non-volatile memory devices within the storage 504, includes a non-transitory computer-readable storage medium.

In some embodiments, storage 504 or the computer-readable storage medium of the storage 504 stores an operating system, which includes procedures for handling various basic system services and for performing hardware dependent tasks. In some embodiments, storage 504 or the computer-readable storage medium of the storage 504 stores a communications module, which is used for connecting EVCS 500 to other computers and devices via the one or more communication network interfaces 506 (wired or wireless), such as the internet, other wide area networks, local area networks, metropolitan area networks, and so on. In some embodiments, storage 504 or the computer-readable storage medium of the storage 504 stores a media item module for selecting and/or displaying media items on the display(s) 520 to be viewed by passersby and users of EVCS 500. In some embodiments, storage 504 or the computer-readable storage medium of the storage 504 stores an EVCS module for charging an electric vehicle (e.g., measuring how much charge has been delivered to an electric vehicle, commencing charging, ceasing charging, etc.), including a motor control module that includes one or more instructions for energizing or forgoing energizing the motor. In some embodiments, storage 504 or computer-readable storage medium of the storage 504 stores a parking space status module (e.g., parking space status module 204). In some embodiments, executable modules, applications, or sets of procedures may be stored in one or more of the previously mentioned memory devices and corresponds to a set of instructions for performing a function described above. In some embodiments, modules or programs (i.e., sets of instructions) need not be implemented as separate software programs, procedures, or modules, and thus various subsets of modules may be combined or otherwise re-arranged in various implementations. In some embodiments, the storage 504 stores a subset of the modules and data structures identified above. In some embodiments, the storage 504 may store additional modules or data structures not described above.

In some embodiments, EVCS 500 comprises additional peripherals 508 such as displays 520 for displaying content, and charging cable 522. In some embodiments, the displays 520 may be touch-sensitive displays that are configured to detect various swipe gestures (e.g., continuous gestures in vertical and/or horizontal directions) and/or other gestures (e.g., a single or double tap) or to detect user input via a soft keyboard that is displayed when keyboard entry is needed.

In some embodiments, EVCS 500 comprises one or more sensors 510 such as cameras (e.g., camera 116, described above with respect to FIG. 1), ultrasound sensors, depth sensors, IR cameras, RGB cameras, PIR cameras, thermal IR, proximity sensors, radar, tension sensors, NFC sensors, and/or any combination thereof. In some embodiments, the one or more sensors 510 are for detecting whether external objects are within a region proximal to EVCS 500, such as living and nonliving objects, and/or the status of EVCS 500 (e.g., available, occupied, etc.) in order to perform an operation, such as determining a vehicle characteristic, user information, region status, etc.

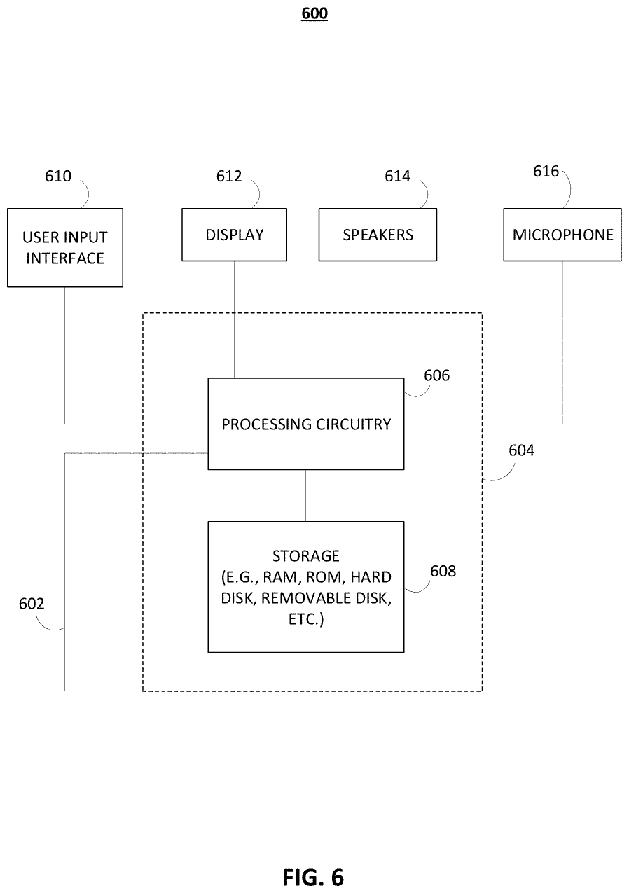

FIG. 6 shows an illustrative block diagram of a user equipment device system, in accordance with some embodiments of the disclosure. In practice, and as recognized by those of ordinary skill in the art, items shown separately could be combined and some items could be separated. In some embodiments, not all shown items must be included in device 600. In some embodiments, device 600 may comprise additional items. In an embodiment, the user equipment device 600, is the same user equipment device displayed in FIG. 1. The user equipment device 600 may receive content and data via I/O path 602. The I/O path 602 may provide audio content (e.g., broadcast programming, on-demand programming, Internet content, content available over a LAN or WAN, and/or other content) and data to control circuitry 604, which includes processing circuitry 606 and a storage 608. The control circuitry 604 may be used to send and receive commands, requests, and other suitable data using the I/O path 602. The I/O path 602 may connect the control circuitry 604 (and specifically the processing circuitry 606) to one or more communications paths. I/O functions may be provided by one or more of these communications paths but are shown as a single path in FIG. 6 to avoid overcomplicating the drawing.

The control circuitry 604 may be based on any suitable processing circuitry such as the processing circuitry 606. As referred to herein, processing circuitry should be understood to mean circuitry based on one or more microprocessors, microcontrollers, digital signal processors, programmable logic devices, FPGAs, ASICs, etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor).

In client-server-based embodiments, the control circuitry 604 may include communications circuitry suitable for communicating with one or more servers that may at least implement the described allocation of services functionality. The instructions for carrying out the above-mentioned functionality may be stored on the one or more servers. Communications circuitry may include a cable modem, an ISDN modem, a DSL modem, a telephone modem, Ethernet card, or a wireless modem for communications with other equipment, or any other suitable communications circuitry. Such communications may involve the Internet or any other suitable communications networks or paths. In addition, communications circuitry may include circuitry that enables peer-to-peer communication of user equipment devices, or communication of user equipment devices in locations remote from each other (described in more detail below).

Memory may be an electronic storage device provided as the storage 608 that is part of the control circuitry 604. Storage 608 may include random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid-state devices, quantum storage devices, gaming consoles, gaming media, or any other suitable fixed or removable storage devices, and/or any combination of the same. The storage 608 may be used to store various types of content described herein. Nonvolatile memory may also be used (e.g., to launch a boot-up routine and other instructions). Cloud-based storage may be used to supplement the storage 608 or instead of the storage 608.

The control circuitry 604 may include audio generating circuitry and tuning circuitry, such as one or more analog tuners, audio generation circuitry, filters or any other suitable tuning or audio circuits or combinations of such circuits. The control circuitry 604 may also include scaler circuitry for upconverting and down converting content into the preferred output format of the user equipment device 600. The control circuitry 604 may also include digital-to-analog converter circuitry and analog-to-digital converter circuitry for converting between digital and analog signals. The tuning and encoding circuitry may be used by the user equipment device 600 to receive and to display, to play, or to record content. The circuitry described herein, including, for example, the tuning, audio generating, encoding, decoding, encrypting, decrypting, scaler, and analog/digital circuitry, may be implemented using software running on one or more general purpose or specialized processors. If the storage 608 is provided as a separate device from the user equipment device 600, the tuning and encoding circuitry (including multiple tuners) may be associated with the storage 608.

The user may utter instructions to the control circuitry 604 which are received by the microphone 616. The microphone 616 may be any microphone (or microphones) capable of detecting human speech. The microphone 616 is connected to the processing circuitry 606 to transmit detected voice commands and other speech thereto for processing. In some embodiments, voice assistants (e.g., Siri, Alexa, Google Home, and similar such voice assistants) receive and process the voice commands and other speech.

The user equipment device 600 may optionally include an interface 610. The interface 610 may be any suitable user interface, such as a remote control, mouse, trackball, keypad, keyboard, touch screen, touchpad, stylus input, joystick, or other user input interfaces. A display 612 may be provided as a stand-alone device or integrated with other elements of the user equipment device 600. For example, the display 612 may be a touchscreen or touch-sensitive display. In such circumstances, the interface 610 may be integrated with or combined with the microphone 616. When the interface 610 is configured with a screen, such a screen may be one or more of a monitor, a television, a liquid crystal display (LCD) for a mobile device, active matrix display, cathode ray tube display, light-emitting diode display, organic light-emitting diode display, quantum dot display, or any other suitable equipment for displaying visual images. In some embodiments, the interface 610 may be HDTV-capable. In some embodiments, the display 612 may be a 3D display. The speaker (or speakers) 614 may be provided as integrated with other elements of user equipment device 600 or may be a stand-alone unit. In some embodiments, the display 612 may be outputted through speaker 614.

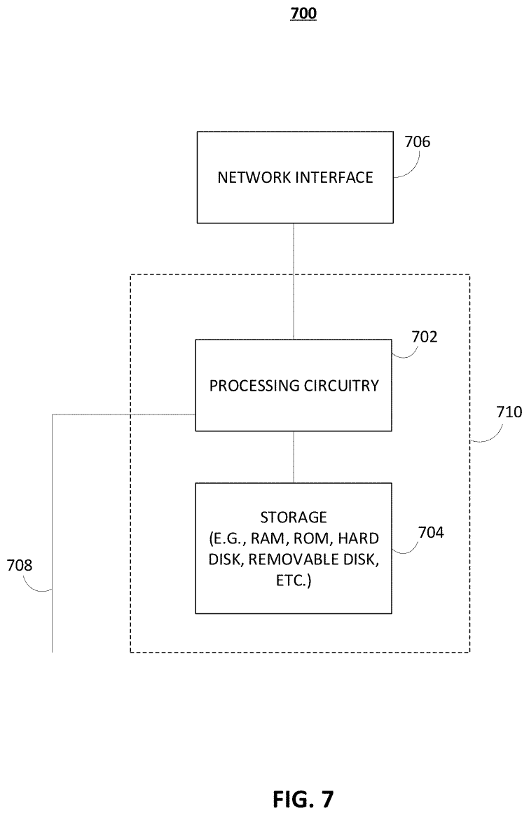

FIG. 7 shows an illustrative block diagram of a server system 700, in accordance with some embodiments of the disclosure. Server system 700 may include one or more computer systems (e.g., computing devices), such as a desktop computer, a laptop computer, and a tablet computer. In some embodiments, the server system 700 is a data server that hosts one or more databases (e.g., databases of images or videos), models, or modules or may provide various executable applications or modules. In practice, and as recognized by those of ordinary skill in the art, items shown separately could be combined and some items could be separated. In some embodiments, not all shown items must be included in server system 700. In some embodiments, server system 700 may comprise additional items.

The server system 700 can include processing circuitry 702 that includes one or more processing units (processors or cores), storage 704, one or more network or other communications network interfaces 706, and one or more I/O paths 708. I/O paths 708 may use communication buses for interconnecting the described components. I/O paths 708 can include circuitry (sometimes called a chipset) that interconnects and controls communications between system components. Server system 700 may receive content and data via I/O paths 708. The I/O path 708 may provide data to control circuitry 710, which includes processing circuitry 702 and a storage 704. The control circuitry 710 may be used to send and receive commands, requests, and other suitable data using the I/O path 708. The I/O path 708 may connect the control circuitry 710 (and specifically the processing circuitry 702) to one or more communications paths. I/O functions may be provided by one or more of these communications paths but are shown as a single path in FIG. 7 to avoid overcomplicating the drawing.

The control circuitry 710 may be based on any suitable processing circuitry such as the processing circuitry 702. As referred to herein, processing circuitry should be understood to mean circuitry based on one or more microprocessors, microcontrollers, digital signal processors, programmable logic devices, FPGAs, ASICs, etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor).

Memory may be an electronic storage device provided as the storage 704 that is part of the control circuitry 710. Storage 704 may include random-access memory, read-only memory, high-speed random-access memory (e.g., DRAM, SRAM, DDR RAM, or other random-access solid-state memory devices), non-volatile memory, one or more magnetic disk storage devices, optical disk storage devices, flash memory devices, other non-volatile solid-state storage devices, quantum storage devices, and/or any combination of the same.

In some embodiments, storage 704 or the computer-readable storage medium of the storage 704 stores an operating system, which includes procedures for handling various basic system services and for performing hardware dependent tasks. In some embodiments, storage 704 or the computer-readable storage medium of the storage 704 stores a communications module, which is used for connecting the server system 700 to other computers and devices via the one or more communication network interfaces 706 (wired or wireless), such as the internet, other wide area networks, local area networks, metropolitan area networks, and so on. In some embodiments, storage 704 or the computer-readable storage medium of the storage 704 stores a web browser (or other application capable of displaying web pages), which enables a user to communicate over a network with remote computers or devices. In some embodiments, storage 704 or the computer-readable storage medium of the storage 704 stores a database for storing information on electric vehicle charging stations, their locations, media items displayed at respective electric vehicle charging stations, a number of each type of impression count associated with respective electric vehicle charging stations, user profiles, and so forth.

In some embodiments, executable modules, applications, or sets of procedures may be stored in one or more of the previously mentioned memory devices and corresponds to a set of instructions for performing a function described above. In some embodiments, modules or programs (i.e., sets of instructions) need not be implemented as separate software programs, procedures, or modules, and thus various subsets of modules may be combined or otherwise re-arranged in various implementations. In some embodiments, the storage 704 stores a subset of the modules and data structures identified above. In some embodiments, the storage 704 may store additional modules or data structures not described above.

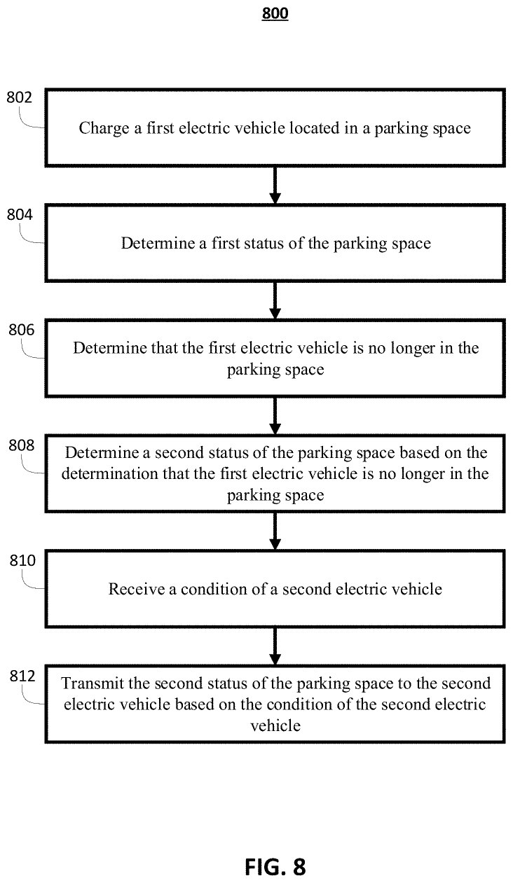

FIG. 8 is an illustrative flowchart of a process 800 for managing an EVCS's parking space, in accordance with some embodiments of the disclosure. Process 800 may be performed by physical or virtual control circuitry, such as control circuitry 518 of EVCS (FIG. 5). In some embodiments, some steps of process 800 may be performed by one of several devices (e.g., user device 600, server 700, etc.).

At step 802, control circuitry charges an electric vehicle located in a parking space. In some embodiments, the control circuitry causes an EVCS to provide an electric charge to the electric vehicle in the parking space via a wired connection, such as a charging cable, or a wireless connection (e.g., wireless charging). In some embodiments, the control circuitry communicates with the electric vehicle and/or a user device belonging to a user that is associated with the electric vehicle during charging. In some embodiments, the control circuitry communicates with one or more devices or computer systems via a network during charging.

At step 804, control circuitry determines a first status of the parking space. In some embodiments, to determine a first status the control circuitry receives parking space information related to the parking space. In some embodiments, the control circuitry uses one or more sensors to capture parking space information. For example, the sensors may be image (e.g., optical) sensors (e.g., one or more cameras 116), ultrasound sensors, depth sensors, IR cameras, RGB cameras, PIR cameras, thermal IR, proximity sensors, radar, tension sensors, NFC sensors, and/or any combination thereof. In some embodiments, the control circuitry determines the first status of the parking space using the parking space information. For example, if the sensors determine that an electric vehicle is located in the parking space, the first status may be “Occupied.”

In some embodiments, the control circuitry determines the first status based on the parking space information and user information. In some embodiments, the control circuitry receives the user information (e.g., user location, user calendars, user purchases, user patterns, etc.) relating to a user of the electric vehicle from a profile associated with the user. In some embodiments, the control circuitry can use more than one type of user information or parking space information to determine the first status. In some embodiments, control circuitry weights different user information and parking space information according to significance. For example, a first user information may indicate that the user has an upcoming event in one hour and a second user information may indicate that the user made a purchase two weeks ago. In some embodiments, the control circuitry weights the first user information higher than the second user information and bases the first status on the first user information.

In some embodiments, the control circuitry uses the received parking space information and/or the received user information to determine a time period for the first status. In some embodiments, the control circuitry accesses a database with entries that associate user information and/or parking space information with estimated time periods. In some embodiments, a first entry indicates that a user loading groceries into the electric vehicle parked in the parking space corresponds to approximately 10 minutes (time period) until the electric vehicle leaves the parking space. In some embodiments, one or more entries specify that users with children loading groceries correspond to a longer time period than users without children loading groceries. In some embodiments, the database comprises customized entries based on certain users. In some embodiments, the control circuitry includes the estimated time period in and/or along with the first status.

At step 806, control circuitry determines that the first electric vehicle is no longer in the parking space. In some embodiments, the control circuitry uses the same or similar methods describes above in step 804 to determine that the first electric vehicle is no longer in the parking space. In some embodiments, the control circuitry determines the first electric vehicle is no longer in the parking space using updated parking space information.

At step 808, control circuitry determines a second status of the parking space based on the determination that the first electric vehicle is no longer in the parking space. For example, if the sensors determine that there is no longer an electric vehicle in the parking space, the second status may be “Available.” In some embodiments, the control circuitry determines the second status using similar or the same methodologies described above in step 804.

At step 810, control circuitry receives a condition of a second electric vehicle. In some embodiments, the condition is part of a charging request sent by the second electric vehicle. In some embodiments, the condition may be related to vehicle information (e.g., location of the electric vehicle, battery charge of the electric vehicle, time of charge required, etc.). In some embodiments, the condition may be related to additional information such as queue of charging requests, auction of parking spaces, user information, etc. In some embodiments, the condition is part of a charging request sent by a user device associated with the second electric vehicle. In some embodiments, the condition is part of a first charging request of a plurality of charging requests. For example, the control circuitry may receive charging requests from a plurality of electric vehicles, wherein one or more of the charging requests have conditions relating to the electric vehicle associated with the charging request.

At step 812, control circuitry transmits the second status to the second electric vehicle based on the condition of the second electric vehicle. In some embodiments, the control circuitry transmits the second status to the second electric vehicle because the second electric vehicle is within a threshold distance (e.g., one mile) of the location of the parking space. In some embodiments, the control circuitry transmits the second status to the second electric vehicle because the second electric vehicle is subscribed to a spot notification service. In some embodiments, the control circuitry transmits the second status to the second electric vehicle because the second electric vehicle has charging below a first threshold (e.g., less than 20% charged). In some embodiments, the control circuitry transmits the second status to the second electric vehicle because there is a queue of electric vehicles requesting parking spaces and the second electric vehicle is next in the queue to receive a parking space. In some embodiments, the control circuitry transmits the second status to a database comprising a plurality of entries listing parking space statuses and one or more devices associated with the database sends the second status to the second electric vehicle.

In some embodiments, one or more conditions are weighted to determine an electric vehicle to receive the second status from the control circuitry. For example, the percent charge of an electric vehicle may be weighted lower than a user bidding the highest amount for an EVCS parking space. In some embodiments, a user device and/or an electric vehicle transmits a charging request using one or more data packets (e.g., using IPv6) to the one or more devices maintaining table 350. In some embodiments, the same device or devices that maintain table 300 also maintain table 350. In some embodiments, machine learning is utilized to determine that the second status of the parking space should be transmitted to the second electric vehicle.

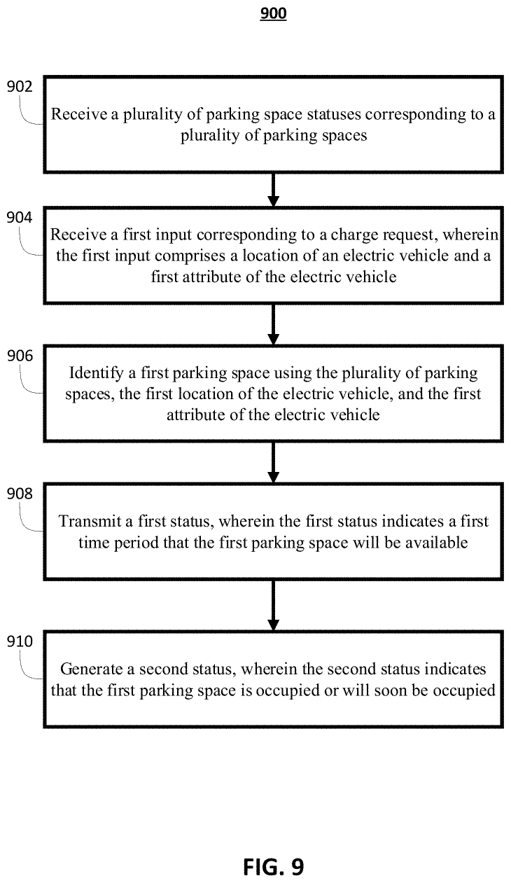

FIG. 9 is another illustrative flowchart of a process 900 for managing an EVCS's parking space, in accordance with some embodiments of the disclosure. Process 900 may be performed by physical or virtual control circuitry, such as control circuitry 518 of EVCS (FIG. 5). In some embodiments, some steps of process 900 may be performed by one of several devices (e.g., user device 600, server 700, etc.).

At step 902, control circuitry receives a plurality of parking space statuses corresponding to a plurality of parking spaces. In some embodiments, a plurality of EVCSs send the plurality of parking space statuses over a network. In some embodiments, the plurality of parking space statuses comprise parking space information and/or EVCS information. For example, each parking space status can contain some or all of the information displayed in table 300 (e.g., EVCS identifier, Location, Status, Additional Information, User) for a given EVCS. In some embodiments, one or more EVCSs transmit parking space statuses whenever there is a change in EVCS information. For example, if a first EVCS's parking space status changes from “Occupied” to “Available” the first EVCS can send a parking space status to the control circuitry. In some embodiments, one or more EVCSs transmit parking space statuses after a certain time period (e.g., every five seconds, every minute, every 10 minutes, etc.). In some embodiments, one or more EVCSs transmit parking space statuses whenever requested (e.g., from the control circuitry). In some embodiments, one or more EVCSs transmit parking space statuses using one or more data packets (e.g., using IPv6) to the control circuitry.

At step 904, control circuitry receives a first input corresponding to a charge request, wherein the first input comprises a location of an electric vehicle and a first attribute of the electric vehicle. In some embodiments, the first input is received when a user device associated with the electric vehicle or the electric vehicle transmits a charge request to the control circuitry. In some embodiments, the charge request comprises the location and the first attribute. In some embodiments, the first input is a charging request of a plurality of charging requests. For example, the control circuitry may receive charging requests from a plurality of electric vehicles, wherein one or more of the charging requests have attributes relating to the electric vehicle associated with the charging request. In some embodiments, the attribute may be related to vehicle information (e.g., location of the electric vehicle, battery charge of the electric vehicle, time of charge required, etc.). In some embodiments, the attribute may be related to additional information such as queue of charge requests, auction of parking spaces, user information, etc.

At step 906, control circuitry identifies a first parking space using the plurality of parking space statuses, the first location of the electric vehicle, and the first attribute of the electric vehicle. In some embodiments, the control circuitry identifies the first parking space because it corresponds to the closest available parking space for the electric vehicle. In some embodiments, control circuitry identifies the first parking space because it corresponds to the second closest available parking space for the electric vehicle and the electric vehicle has a battery percentage within a threshold to travel to the first parking space, despite it not being the closest parking space. In some embodiments, the control circuitry selects the second closest available parking space because the control circuitry determines the first closest parking space should be reserved for a second electric vehicle based on the second electric vehicle's attribute (e.g., having a lower battery percentage than the first electric vehicle). In some embodiments, one or more conditions are weighted to identify the first parking space for the electric vehicle. For example, the percent charge of the electric vehicle may be weighted lower than additional information corresponding to a user associated with the electric vehicle bidding the highest amount for an EVCS parking space. In some embodiments, machine learning is utilized to identify the first parking space of an EVCS from table 300 for the electric vehicle.

At step 908, control circuitry transmits a first status, where the first status indicates a first time period that the first parking space will be available. In some embodiments, the control circuitry uses user information and/or parking space information to determine the first time period that the first parking space will be available. In some embodiments, control circuitry determines a first activity using the user information. In some embodiments, the control circuitry associates certain types of user information with activity types. For example, the control circuitry may associate user information relating to a user purchasing an item with a purchasing activity. In another example, the control circuitry may associate user information relating to a user loading groceries into the electric vehicle as a loading activity. In some embodiments, the control circuitry uses one or more machine learning algorithms to determine the first activity using the user information. In some embodiments, the control circuitry accesses a database comprising entries that match user information with activity types. For example, an entry may associate user information related to a user crossing a geofence located at the exit of a location as a departure activity. In some embodiments, user information can correspond to more than one activity type. In some embodiments, an activity type can correspond to more than one piece of user information.

In some embodiments, control circuitry determines that a first activity corresponds to a second electric vehicle leaving the first parking space within a first time period. In some embodiments, the control circuitry accesses a database with entries that associate activities with estimated time periods. In some embodiments, a first entry of the database indicates that the first activity (e.g., loading activity) corresponds to a first time period (e.g., approximately 10 minutes). In some embodiments, the first time period is based on past user behavior. For example, if the user takes an average of 10 minutes to load the second electric vehicle, the first time period may be approximately 10 minutes. In some embodiments, the first time period is based on the past behaviors of users. For example, if the recorded average of all users indicates that it takes about 10 minutes to load an electric vehicle, then the first time period may be approximately 10 minutes. In some embodiments, a second entry indicates that a second activity (e.g., purchase activity) corresponds to a second time period (e.g., approximately five minutes) until the second electric vehicle leaves the parking space. In some embodiments, the second time period is based on the user's past behavior. For example, because the user usually takes about five minutes to walk to the second electric vehicle from the store, the second time period may be five minutes. In some embodiments, the second time period is based on the past behaviors of users. In some embodiments, the entries provide additional granularity. For example, entries may specify loading activities when children are present correspond to a longer time period than loading activities when children are not present.

At step 910, control circuitry generates a second status, wherein the second status indicates that the first parking space is occupied or will soon be occupied. In some embodiments, the second status is used to update a table (e.g., table 300). In some embodiments, the control circuitry transmits the second status to a device or group of devices. For example, the control circuitry can transmit the second status to a group of devices subscribed to a parking space notification service indicating that the first parking space is no longer available. In some embodiments, the second status is used to reserve the parking space for the electric vehicle.

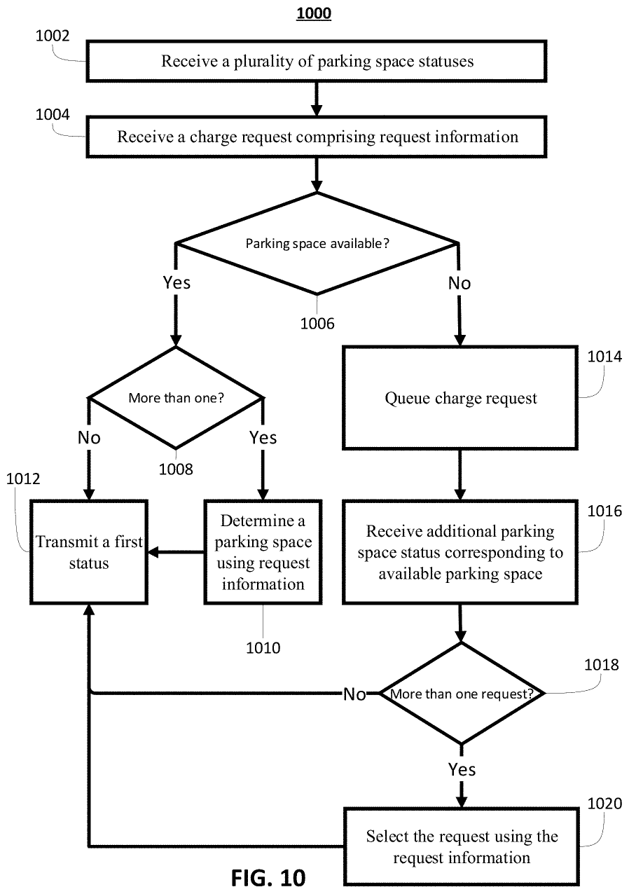

FIG. 10 is another illustrative flowchart of a process 1000 for managing an EVCS's parking space, in accordance with some embodiments of the disclosure. Process 1000 may be performed by physical or virtual control circuitry, such as control circuitry 518 of EVCS (FIG. 5). In some embodiments, some steps of process 1000 may be performed by one of several devices (e.g., user device 600, server 700, etc.).

At step 1002, control circuitry receives a plurality of parking space statuses. In some embodiments, this step uses the same or similar methodologies described in step 902 above.

At step 1004, control circuitry receives a charge request comprising request information. In some embodiments, the control circuitry receives the charge request over a network. In some embodiments, the control circuitry receives the charge request from an electric vehicle and/or a user device associated with the electric vehicle. In some embodiments, a user submits the charge request using the electric vehicle and/or a user device associated with the electric vehicle. In some embodiments, the electric vehicle and/or user device automatically submits the charge request in response to vehicle information (e.g., the electric vehicle's battery falling below a first threshold). In some embodiments, the charge request comprises request information. In some embodiments, request information can include some or all of the information displayed in table 350 (e.g., Request identifier, User, Time Requested, Distance to EVCS, Vehicle Information, Additional Information, etc.) for the electric vehicle. In some embodiments, the charge request also comprises additional request information (e.g., request for a brand of charger, request for a category (Level 1, Level 2, Level 3, etc.) of charger, request for chargers within a certain location, etc.).

At step 1006, control circuitry determines if a parking space is available. In some embodiments, the control circuitry uses the plurality of parking space statuses received in step 1002 and/or the request information to determine if a parking space is available for the electric vehicle associated with the charge request. In some embodiments, the control circuitry determines the availability of a parking space using one or more factors. In some embodiments, a parking space is considered available if the received parking space status corresponding to the parking space indicates an “available” status for the time requested by the charge request. In some embodiments, a parking space is considered available if the received parking space status corresponding to the parking space indicates an “available” status for the time requested by the charge request and the parking space is within a threshold distance of the electric vehicle. In some embodiments, the control circuitry calculates the drivable distance of the electric vehicle associated with the charge request using the location of the electric vehicle and the battery percentage of the electric vehicle to determine if an available parking space is within a threshold distance of the electric vehicle. In some embodiments, the control circuitry determines that a parking space that will be available within a threshold time period (e.g., five minutes) of the electric vehicle arriving is considered available. For example, if a parking space status indicates that the corresponding parking space will be available in 20 minutes, and the electric vehicle will arrive at the parking space in 15 minutes, the control circuitry can consider the parking space as available. In some embodiments, the threshold time period may vary based on the availability and/or location of other parking spaces. For example, control circuitry may consider a first parking space, within one mile from the electric vehicle, that will not be available until 10 minutes after the electric vehicle arrives as available if the other parking spaces within 20 miles of the electric vehicle are not available. If there is a parking space available, the process 1000 continues to step 1008. If there is not a parking space available, then the process 1000 continues to step 1014.

At step 1008, control circuitry determines if there is more than one parking space available. If there is more than one parking space available, the process 1000 continues to step 1010. If there is not a parking space available then the process 1000 continues to step 1012, where the parking space status related to the only available parking space is transmitted to the device (e.g., electric vehicle and/or user device) that submitted the charge request.

At step 1010, control circuitry determines a parking space using the request information. For example, the control circuitry may determine a first available parking space is closer to the location of the electric vehicle (request information) associated with the charge request than a second available parking space and select the closer available parking space. In some embodiments, the control circuitry selects a second closest available parking space because the control circuitry determines the first closest parking space should be reserved for a second electric vehicle based on the second electric vehicle's information (e.g., having a lower battery percentage than the electric vehicle associated with the charge request). In some embodiments, one or more conditions are weighted to select the available parking space for the electric vehicle associated with the charge request. In some embodiments, machine learning is utilized to select the parking space of an EVCS from table 300 for the electric vehicle associated with the charge request.

At step 1012, control circuitry transmits a first status. In some embodiments, the first status relates to the parking space identified in step 1006, step 1010, step 1018, or step 1020. In some embodiments, the first status is transmitted to the device (e.g., electric vehicle and/or user device) that submitted the charge request.

At step 1014, control circuitry queues the charge request. In some embodiments, the charge request is stored in a table of a database such as table 350. In some embodiments, more than one charge request can be queued and/or stored in the database.

At step 1016, control circuitry receives one or more additional parking space status corresponding to available parking spaces. In some embodiments, the additional parking space statuses are received using the same or similar methodologies as described in step 902 above. In some embodiments, the additional parking space statuses are received due to changes in the previously submitted parking space statuses. In some embodiments, a first additional parking space status corresponds to an available parking space. In some embodiments, the availability of the parking spaces corresponding to the additional parking space statuses is determined using the same or similar methodologies described in step 1006 above.

At step 1018, control circuitry determines if there is more than one queued charge request. If there is more than one charge request, the process 1000 continues to step 1020. If there is not more than one charge request, the process 1000 continues to step 1012, where the control circuitry transmits the first status corresponding to the available parking space to the device that submitted the charge request.

At step 1020, control circuitry selects the charge request using the request information. In some embodiments, the charge request is a first charge request of a plurality of charge requests. In some embodiments, the plurality of charge requests are received in the same or similar method in which the charge request is received in step 1004. In some embodiments, the request information is used to select the charge request from the plurality of charge requests. For example, the control circuitry may select the first charge request because the electric vehicle associated with the first charge request is the closest to the location of the available parking space compared to the other electric vehicles corresponding to the other charge requests. In another example, the control circuitry may select the first charge request because the first charge request bid the highest for the next available spot compared to the other charge requests. In another example, the control circuitry may select the first charge request because the electric vehicle associated with the first charge request may have the lowest battery percentage compared to the other electric vehicles corresponding to the other charge requests. In another example, the control circuitry may select the first charge request because the first charge request is next in the queue of the charge requests. In some embodiments, request information corresponding to the plurality of charge requests is weighted to select the first charge request from the plurality of charge requests. In some embodiments, machine learning is utilized to select the first charge request from the plurality of charge requests. In some embodiments, the first status corresponds to the available parking space of step 1016 and is transmitted to the device associated with the first charge request (the charge request selected in step 1020) at step 1012.

It is contemplated that some suitable steps or suitable descriptions of FIGS. 8-10 may be used with other suitable embodiments of this disclosure. In addition, some suitable steps and descriptions described in relation to FIGS. 8-10 may be implemented in alternative orders or in parallel to further the purposes of this disclosure. For example, some suitable steps may be performed in any order or in parallel or substantially simultaneously to reduce lag or increase the speed of the system or method. Some suitable steps may also be skipped or omitted from the process. Furthermore, it should be noted that some suitable devices or equipment discussed in relation to FIGS. 1-7 could be used to perform one or more of the steps in FIGS. 8-10.

The processes discussed above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
charging, by an electric vehicle charging station, a first electric vehicle located in a parking space;
determining, by the electric vehicle charging station, a first status of the parking space based on the first electric vehicle being in the parking space;
determining, by the electric vehicle charging station, that the first electric vehicle is no longer in the parking space;
determining, by the electric vehicle charging station, a second status of the parking space based on the determination that the first electric vehicle is no longer in the parking space;
receiving, by the electric vehicle charging station, a condition of a second electric vehicle; and
transmitting, by the electric vehicle charging station, the second status of the parking space to the second electric vehicle based on the condition of the second electric vehicle.

2. The method of claim 1, further comprising:
receiving, by the electric vehicle charging station, a plurality of charge requests corresponding to a plurality of electric vehicles, wherein the plurality of charge requests comprise a plurality of conditions relating to the plurality of electric vehicles;
determining, by the electric vehicle charging station, that the second status of the parking space corresponds to an available parking space; and
selecting the second electric vehicle to receive the second status of the parking space based on the condition of the second electric vehicle compared to the plurality of conditions relating to the plurality of electric vehicles.

3. The method of claim 2, wherein determining a first status of the parking space further comprises:
receiving user information related to the first electric vehicle;
determining that the user information corresponds to a first activity; and
determining that the first activity corresponds to an action indicating that the first electric vehicle will leave the first parking space within a first time period.

4. The method of claim 3, wherein the user information corresponds to one or more events in a calendar and the calendar is associated with a user of the first electric vehicle.

5. The method of claim 3, wherein the user information corresponds to a user making a purchase and the user is associated with the first electric vehicle.

6. The method of claim 3, wherein the user information corresponds to a device crossing a first geofence, wherein the device is associated with the first electric vehicle.

7. The method of claim 3, wherein the user information corresponds to a profile associated with a user of the first electric vehicle and the profile comprises one or more past estimated charge times.

8. The method of claim 1, wherein the condition relates to the charge of the battery of the second electric vehicle being within a first threshold.

9. The method of claim 1, wherein the condition relates to the location of the second electric vehicle being within a first threshold distance of the electric vehicle charging station.

10. The method of claim 1, wherein the condition relates to the second electric vehicle being next in a queue of electric vehicles requesting charging.

11. The method of claim 1, wherein the condition relates to the second electric vehicle paying for the next available parking space within a threshold distance.

12. The method of claim 1, further comprising, determining, by the electric vehicle charging station, that the electric vehicle is located in the parking space using one or more sensors of the electric vehicle charging station.

13. An apparatus comprising:
control circuitry; and
at least one memory including computer program code for one or more programs, the at least one memory and the computer program code configured to, with the control circuitry, cause the apparatus to perform at least the following:
charge a first electric vehicle located in a parking space;
determine a first status of the parking space based on the first electric vehicle being in the parking space;
determine that the first electric vehicle is no longer in the parking space;
determine a second status of the parking space based on the determination that the first electric vehicle is no longer in the parking space;
receive a condition of a second electric vehicle; and
transmit the second status of the parking space to the second electric vehicle based on the condition of the second electric vehicle.

14. The apparatus of claim 13, wherein the apparatus is further caused to:
receive a plurality of charge requests corresponding to a plurality of electric vehicles, wherein the plurality of charge requests comprise a plurality of conditions relating to the plurality of electric vehicles;
determine that the second status of the parking space corresponds to an available parking space; and
select the second electric vehicle to receive the second status of the parking space based on the condition of the second electric vehicle compared to the plurality of conditions relating to the plurality of electric vehicles.

15. The apparatus of claim 14, wherein the apparatus is further caused, when determining a first status of the parking space, to:
receive user information related to the first electric vehicle;
determine that the user information corresponds to a first activity; and
determine that the first activity corresponds to an action indicating that the first electric vehicle will leave the first parking space within a first time period.

16. The apparatus of claim 15, wherein the user information corresponds to one or more events in a calendar and the calendar is associated with a user of the first electric vehicle.

17. The apparatus of claim 15, wherein the user information corresponds to a user making a purchase and the user is associated with the first electric vehicle.

18. The apparatus of claim 15, wherein the user information corresponds to a device crossing a first geofence, wherein the device is associated with the first electric vehicle.

19. The apparatus of claim 15, wherein the user information corresponds to a profile associated with a user of the first electric vehicle and the profile comprises one or more past estimated charge times.

20. The apparatus of claim 15, wherein the condition relates to the charge of the battery of the second electric vehicle being within a first threshold.

21.-36. (canceled)
